(19) United States
(12) Patent Application Publication
(10) Pub. No.: US 2026/0188719 A1
(43) Pub. Date: Jul. 2, 2026

(54) METHOD FOR MANUFACTURING BATTERY MODULE, AND JIG

(71) Applicant: SUBARU CORPORATION, Tokyo (JP)

(72) Inventor: Masazumi MIYAGO, Tokyo (JP)

(21) Appl. No.: 19/417,410

(22) Filed: Dec. 12, 2025

(30) Foreign Application Priority Data
Dec. 27, 2024 (JP) 2024-232092

(51) Int. Cl. H01M 10/04; H01M 10/625; H01M 10/643; H01M 10/647; H01M 10/6555; H01M 10/6557

(52) U.S. Cl. CPC H01M 10/0404; H01M 10/625; H01M 10/6555; H01M 10/6557; H01M 10/643; H01M 10/647

(57) ABSTRACT

There is provided a method for manufacturing a battery module. The battery module includes a stacked body in which units are stacked. Each unit includes a first cell group and a second cell group in which cells are arranged, and a temperature control plate. The method includes: disposing a first jig including a first elastic body across the first cell group on a first side of the temperature control plate; disposing a second jig including a second elastic body across the second cell group on a second side of the temperature control plate; and pressing the first cell group and the second cell group against the temperature control plate by bringing the first jig and the second jig close to each other such that the first elastic body is in contact with the first cell group and the second elastic body is in contact with the second cell group.

### CROSS-REFERENCE TO RELATED APPLICATIONS

The present application claims priority from Japanese Patent Application No. 2024-232092 filed on Dec. 27, 2024, the entire contents of which are hereby incorporated by reference.

### BACKGROUND

The present disclosure relates to a method for manufacturing a battery module, and a jig.

Conventionally, there has been known an electric vehicle that can travel using a motor using electric power stored in a battery module in a battery pack. For example, Japanese Unexamined Patent Application Publication (Translation of PCT Application) (JP-T) No. 2023-502274 discloses a battery pack that is disposed at the center of a lower portion of a vehicle body of an electric vehicle and includes battery modules. The battery module of JP-T No. 2023-502274 includes a stacked body in which units each including a first cell group, a second cell group, and a temperature control plate disposed between the first cell group and the second cell group are stacked.

### SUMMARY

An aspect of the disclosure provides a method for manufacturing a battery module. The battery module includes a stacked body in which units are stacked. Each unit includes a first cell group and a second cell group in which cells extending in a first direction are arranged in a second direction orthogonal to the first direction, and a temperature control plate disposed between the first cell group and the second cell group and extending in the second direction. The method includes: disposing a first jig including a first elastic body across the first cell group on a first of the temperature control plate; disposing a second jig including a second elastic body across the second cell group on a second side of the temperature control plate; and pressing the first cell group and the second cell group against the temperature control plate by bringing the first jig and the second jig close to each other such that the first elastic body is in contact with the first cell group and the second elastic body is in contact with the second cell group.

### BRIEF DESCRIPTION OF THE DRAWINGS

The accompanying drawings are included to provide a further understanding of the disclosure and are incorporated in and constitute a part of this specification. The drawings illustrate embodiments and, together with the specification, serve to describe the principles of the disclosure.

FIG. 1 is a side view illustrating a configuration of a vehicle according to an embodiment of the disclosure;

FIG. 2 is a cross-sectional view illustrating a configuration of a battery module according to the embodiment;

FIG. 3 is a schematic configuration view illustrating a configuration of a stacked body according to the embodiment;

FIG. 4 is a flowchart diagram of a method for manufacturing a battery module according to the embodiment;

FIG. 5 is a flowchart diagram of a unit creating step according to the embodiment;

FIG. 6 is a schematic perspective view illustrating a configuration of a temperature control plate according to the embodiment;

FIG. 7 is a schematic view illustrating configurations of a laser measurement apparatus and an application apparatus according to the embodiment;

FIG. 8 is a schematic perspective view of jigs according to the embodiment;

FIG. 9 is a schematic perspective view of jigs according to the embodiment;

FIG. 10 is a schematic view illustrating a state in which the jigs according to the embodiment are disposed with a temperature control plate, a first cell group, and a second cell group interposed therebetween;

FIG. 11 is a schematic view illustrating a state in which the first cell group and the second cell group are pressed against the temperature control plate by the jigs according to the embodiment;

FIG. 12 is a schematic view illustrating a state in which the first cell group and the second cell group are pressed against the temperature control plate by jigs according to a modification;

FIG. 13 is a schematic view illustrating a configuration of a jig according to the embodiment;

FIG. 14 is a schematic cross-sectional view illustrating a state in which a unit is housed in a main body according to the embodiment;

FIG. 15 is a schematic cross-sectional view illustrating a state of the unit pressed by a pair of first pressing members and a second pressing member according to the embodiment;

FIG. 16 is a schematic cross-sectional view illustrating a state in which the jig illustrated in FIG. 15 is reversed 180° about an X axis;

FIG. 17 is a schematic view illustrating a configuration of an insulating sheet according to the present embodiment;

FIG. 18 is a schematic view illustrating a configuration of a rotating body according to the present embodiment; and

FIG. 19 is a schematic view illustrating a configuration of a rotating body according to a modification.

### DETAILED DESCRIPTION

As described in JP-T No. 2023-502274, the battery module includes a large number of parts such as a first cell group, a second cell group, and a temperature control plate. There is a problem that manufacturing of a battery module including such a large number of parts is not easy and involves difficulty.

An object of the present disclosure is to facilitate manufacturing of a battery module.

Hereinafter, an embodiment of the present disclosure will be described in detail with reference to the accompanying drawings. Specific dimensions, materials, numerical values, and the like indicated in such an embodiment are merely examples for facilitating understanding of the disclosure, and do not limit the present disclosure unless otherwise specified. Note that, in the present specification and the drawings, elements having substantially the same function and configuration are denoted by the same reference numerals, and redundant description is omitted, and elements not directly related to the present disclosure are not illustrated.

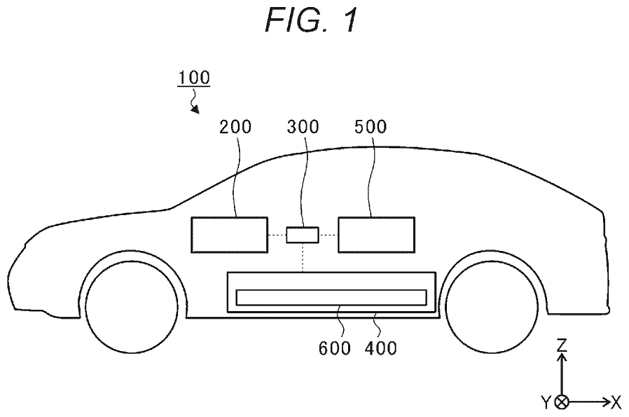

FIG. 1 is a side view illustrating a configuration of a vehicle 100 according to the present embodiment. In FIG. 1, a Z direction indicates a vertical direction, an X direction indicates a predetermined direction in a horizontal direction, and a Y direction indicates a direction orthogonal to the X direction in the horizontal direction. The X direction is, for example, a forward and backward direction of the vehicle 100, and the Y direction is, for example, a left-right direction of the vehicle 100.

The vehicle 100 includes a motor 200, an inverter 300, a battery pack 400, and a control apparatus 500. In the present embodiment, the vehicle 100 is an electric vehicle that travels by driving of the motor 200. However, it is not limited thereto, and the vehicle 100 may be a hybrid vehicle that travels by driving of the motor 200 and an engine, which is not illustrated. Here, configurations related to the features of the present embodiment will be described in detail, and description of configurations unrelated to the features of the present embodiment will be omitted.

The motor 200 obtains driving force by electric power supplied from the battery pack 400 via the inverter 300. The motor 200 transmits the obtained driving force to wheels of the vehicle 100. As a result, the vehicle 100 travels. In addition, the motor 200 also functions as a generator at a timing when no electric power is supplied. The electric power generated by the motor 200 is accumulated in the battery pack 400 via the inverter 300.

The inverter 300 is provided between the motor 200 and the battery pack 400. The inverter 300 electrically couples the motor 200 and the battery pack 400. The inverter 300 converts a direct current supplied from the battery pack 400 into an alternating current and supplies the alternating current to the motor 200. In addition, the inverter 300 is electrically coupled to the control apparatus 500, and adjusts the electric power supplied to the motor 200 based on a control command of the control apparatus 500. Thus, the driving force of the motor 200 is adjusted.

The battery pack 400 is disposed at the center of a lower portion of the vehicle body of the vehicle 100. The battery pack 400 stores high-voltage direct current electric power for driving the motor 200. The battery pack 400 includes at least one battery module 600. In the present embodiment, the battery pack 400 includes battery modules 600, for example, four battery modules 600.

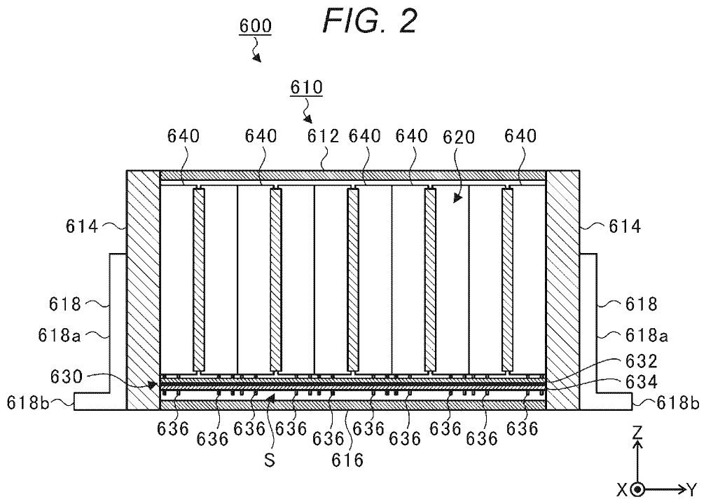

The control apparatus 500 controls the entire vehicle 100. In the present embodiment, the control apparatus 500 mainly controls driving of the motor 200 via the inverter 300. Next, details of the battery module 600 included in the battery pack 400 of the present embodiment will be described with reference to FIG. 2.

FIG. 2 is a cross-sectional view illustrating a configuration of the battery module 600 according to the present embodiment. FIG. 2 illustrates the battery module 600 in a mounted state of being mounted on the battery pack 400. As illustrated in FIG. 2, the battery module 600 includes a case 610, a stacked body 620, and a bus bar module 630.

The case 610 is, for example, a case having a rectangular parallelepiped shape, and forms a housing space S therein. The stacked body 620 and the bus bar module 630 are housed in the housing space S inside the case 610. The case 610 includes an upper cover 612, side plates 614, and a lower cover 616.

The upper cover 612 is disposed on the upper side in the Z direction with respect to the stacked body 620. The upper cover 612 has a rectangular flat plate shape. The upper cover 612 covers the upper side of the stacked body 620 in the Z direction.

A pair of side plates 614 is disposed on both sides in the Y direction with respect to the stacked body 620 and the bus bar module 630. The side plate 614 has a rectangular flat plate shape. The side plates 614 cover both sides of the stacked body 620 and the bus bar module 630 in the Y direction.

The upper cover 612 is coupled to upper ends of the side plates 614 in the Z direction. The lower cover 616 is coupled to lower ends of the side plates 614 in the Z direction. In addition, in the Y direction, brackets 618 are provided on the sides of the side plates 614 opposite to the stacked body 620 and the bus bar module 630. That is, a pair of brackets 618 are provided on the sides of the pair of side plates 614 opposite to the stacked body 620 and the bus bar module 630.

The bracket 618 has, for example, an L shape, and includes a first coupler 618a and a second coupler 618b. The first coupler 618a is a portion extending in the Z direction of the bracket 618 and is a portion coupled to the side plate 614. The second coupler 618b is a portion of the bracket 618 extending in the Y direction from the first coupler 618a, and is a portion coupled to a bottom case, which is not illustrated, of the battery pack 400. The bracket 618 is a fitting for attaching the case 610 of the battery module 600 to the bottom case, which is not illustrated, of the battery pack 400.

The lower cover 616 is disposed on the lower side in the Z direction with respect to the bus bar module 630. The lower cover 616 has a rectangular flat plate shape. The lower cover 616 covers the lower side of the bus bar module 630 in the Z direction.

A space surrounded by the upper cover 612, the side plates 614, and the lower cover 616 is the housing space S.

The stacked body 620 is disposed between the upper cover 612 and the bus bar module 630. The stacked body 620 is formed by stacking units 640 in the Y direction. In the present embodiment, five units 640 are stacked in the Y direction to form the stacked body 620. However, it is not limited thereto, and the stacked body 620 may include a stack of units 640, and for example, may be a stack of six or more units 640, or may be a stack of four or less units 640.

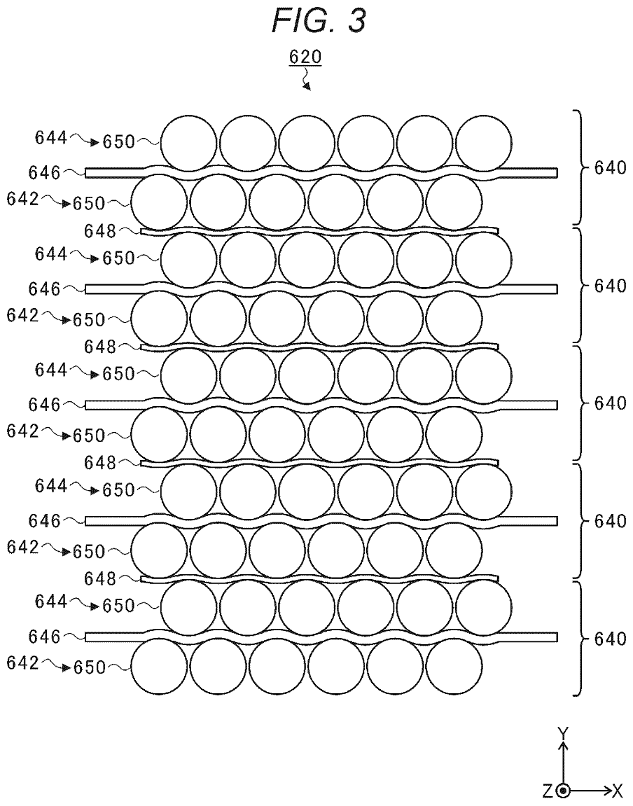

FIG. 3 is a schematic configuration view illustrating a configuration of the stacked body 620 according to the present embodiment. FIG. 3 illustrates a state in which the stacked body 620 illustrated in FIG. 2 is viewed from the Z direction. As illustrated in FIG. 3, the stacked body 620 includes units 640 stacked in the Y direction.

The unit 640 includes a first cell group 642, a second cell group 644, and a temperature control plate 646. Each of the first cell group 642 and the second cell group 644 includes cells 650.

The cell 650 is, for example, a secondary battery such as a nickel-hydrogen battery or a lithium-ion secondary battery. In the present embodiment, the cell 650 has, for example, a cylindrical shape. However, it is not limited thereto, and the cell 650 may have, for example, a triangular prism shape, a quadrangular prism shape, a polygonal prism shape, an elliptical prism shape, or the like. In the example illustrated in FIG. 3, a central axis of the cell 650 extends in the Z direction. Hereinafter, a central axis direction of the cell 650 is also simply referred to as a first direction.

The first cell group 642 is a cell group in which the cells 650 are arranged in the X direction. The direction in which the cells 650 of the first cell group 642 are arranged is a direction orthogonal to the central axis of the cell 650. In the example illustrated in FIG. 3, six cells 650 are arranged in the X direction in the first cell group 642. However, the number of cells 650 in the first cell group 642 may be two or more, and may be five or less or may be seven or more. As described above, the first cell group 642 is configured such that the cells 650 whose central axes extend in the first direction are arranged in a second direction orthogonal to the first direction. Hereinafter, the direction in which the cells 650 are arranged in the first cell group 642 is also simply referred to as a second direction.

The second cell group 644 is a cell group in which the cells 650 are arranged in the X direction. The direction in which the cells 650 of the second cell group 644 are arranged is a direction orthogonal to the central axis of the cell 650. The direction in which the cells 650 of the first cell group 642 are arranged and the direction in which the cells 650 of the second cell group 644 are arranged are the same direction. In the example illustrated in FIG. 3, six cells 650 are arranged in the X direction in the second cell group 644. However, the number of cells 650 in the second cell group 644 may be two or more, and may be five or less or may be seven or more. In addition, the number of cells 650 in the second cell group 644 is the same as the number of cells 650 in the first cell group 642. However, it is not limited thereto, and the number of cells 650 in the second cell group 644 may be different from the number of cells 650 in the first cell group 642. As described above, the second cell group 644 is configured such that the cells 650 whose central axes extend in the first direction are arranged in a second direction orthogonal to the first direction. Hereinafter, the direction in which the cells 650 are arranged in the second cell group 644 is also simply referred to as a second direction.

The temperature control plate 646 is disposed between the first cell group 642 and the second cell group 644. The temperature control plate 646 is a flat plate formed in a corrugated plate shape. An extending direction of the temperature control plate 646 is the X direction, and is a direction in which the first cell group 642 and the second cell group 644 are arranged. That is, the temperature control plate 646 extends in the second direction in which the first cell group 642 and the second cell group 644 are arranged. In the Y direction, one side of the temperature control plate 646 is coupled to the first cell group 642 via an adhesive, and the other side of the temperature control plate 646 is coupled to the second cell group 644 via an adhesive.

A flow path, which is not illustrated, through which a heat medium flows is formed inside the temperature control plate 646. The temperature of each cell 650 of the first cell group 642 and the second cell group 644 can be adjusted by causing the heat medium to flow inside the temperature control plate 646.

For example, each cell 650 of the first cell group 642 and the second cell group 644 can be cooled by causing a refrigerant to flow inside the temperature control plate 646. At this time, the temperature control plate 646 functions as a cooling plate. In addition, each cell 650 of the first cell group 642 and the second cell group 644 can be heated by causing a heating medium to flow inside the temperature control plate 646. At this time, the temperature control plate 646 functions as a heating plate.

An insulating sheet 648 is provided between the units 640. The insulating sheet 648 prevents the first cell group 642 and the second cell group 644 from coming into contact with each other between the units 640, and prevents electrical short circuit and electric leakage. In addition, the insulating sheet 648 reduces heat conduction and prevents heat transfer between the first cell group 642 and the second cell group 644 between the units 640.

Returning to FIG. 2, the bus bar module 630 is disposed between the stacked body 620 and the lower cover 616. The bus bar module 630 includes a bus bar plate 632, bus bars 634, and wires 636. The bus bar plate 632 holds the bus bars 634. The bus bars 634 are disposed on the lower side in the Z direction with respect to the bus bar plate 632. The wires 636 couple a positive electrode and a negative electrode of each cell 650 and the bus bars 634. The bus bars 634 electrically couple electrode terminals of the positive electrode and the negative electrode of each cell 650 via the wires 636.

Next, a method for manufacturing the battery module 600 according to the present embodiment will be described in detail.

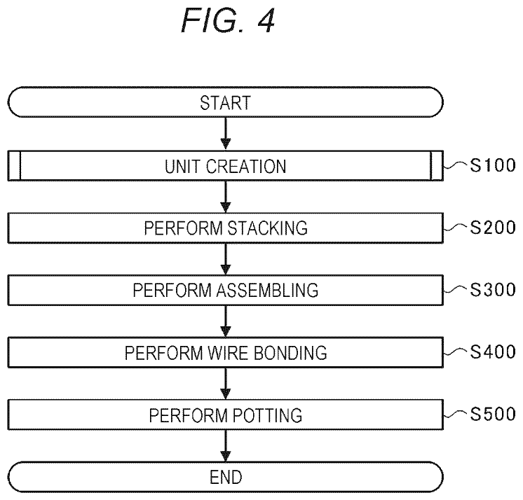

FIG. 4 is a flowchart diagram of a method for manufacturing the battery module 600 according to the present embodiment. As illustrated in FIG. 4, the method for manufacturing the battery module 600 includes a unit creating step S100, a stacking step S200, an assembling step S300, a wire bonding step S400, and a potting step S500.

As will be described in detail below, the unit creating step S100 creates the units 640 each including the first cell group 642, the second cell group 644, and the temperature control plate 646. In the stacking step S200, the created units 640 are stacked to form the stacked body 620. In the assembling step S300, the formed stacked body 620 and the bus bar module 630 are assembled to the case 610.

In the wire bonding step S400, the positive electrode and the negative electrode of each cell 650 and the bus bars 634 are coupled by the wires 636. In the potting step S500, a potting agent is injected into and cured in the stacked body 620 and the bus bar module 630 assembled in the case 610. By curing the injected potting agent, it is possible to improve electrical insulation, fixing, protection, waterproofing, dustproof, durability, weather resistance, and the like of the stacked body 620 and the bus bar module 630 assembled in the case 610.

When the potting agent is cured, the battery module 600 according to the present embodiment is completed. Completed battery modules 600 are housed in the battery pack 400. The battery pack 400 housing the battery modules 600 is mounted on the vehicle 100.

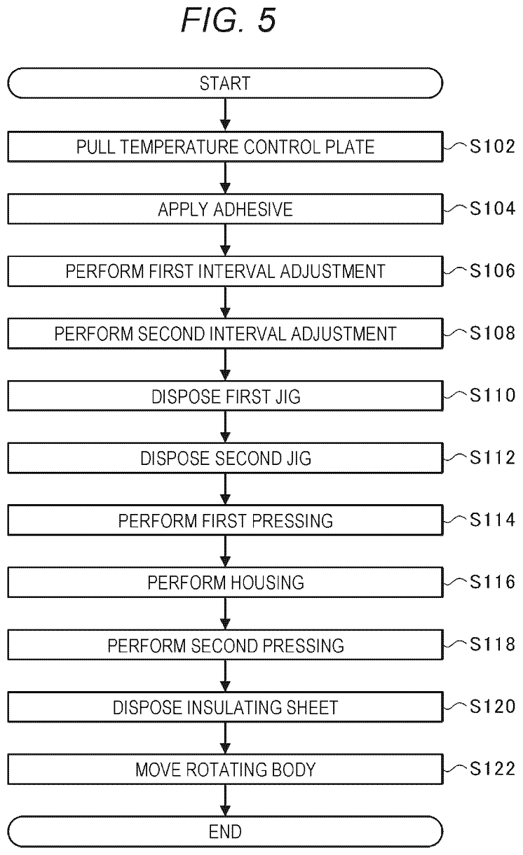

FIG. 5 is a flowchart diagram of the unit creating step S100 according to the present embodiment. As illustrated in FIG. 5, the unit creating step S100 includes a temperature control plate pulling step S102, an adhesive applying step S104, a first interval adjusting step S106, a second interval adjusting step S108, a first jig disposing step S110, a second jig disposing step S112, a first pressing step S114, a housing step S116, a second pressing step S118, an insulating sheet disposing step S120, and a rotating body moving step S122.

The temperature control plate pulling step S102 is a process of holding both ends of the temperature control plate 646 in a longitudinal direction with jigs, which are not illustrated, and pulling both ends of the temperature control plate 646 in the longitudinal direction.

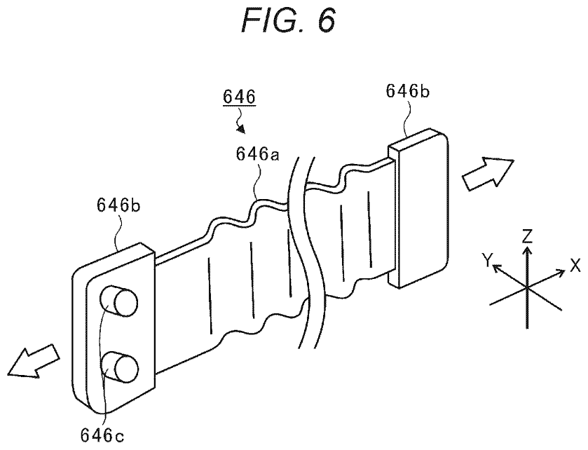

FIG. 6 is a schematic perspective view illustrating a configuration of the temperature control plate 646 according to the present embodiment. As illustrated in FIG. 6, the temperature control plate 646 includes a corrugated plate 646a, a pair of flat plates 646b, and a pair of pipes 646c.

A flow path through which the heat medium can flow is formed inside the corrugated plate 646a. The first cell group 642 is disposed on a −Y direction side of the corrugated plate 646a as described below, and the second cell group 644 is disposed on a +Y direction side of the corrugated plate 646a as described below. The corrugated plate 646a performs heat exchange between the heat medium flowing inside and the first cell group 642 and the second cell group 644.

The pair of flat plates 646b are provided on both sides of the corrugated plate 646a in the X direction. The pair of flat plates 646b have a flat plate shape having a plane parallel to an XZ plane. In the present embodiment, the pair of flat plates 646b serve as both ends of the temperature control plate 646.

The pair of pipes 646c are provided on one of the pair of flat plates 646b. For example, the pair of pipes 646c are provided on the flat plate 646b on an −X direction side with respect to the corrugated plate 646a. The pair of pipes 646c are provided side by side in the Z direction. One of the pair of pipes 646c supplies the heat medium to the inside of the corrugated plate 646a. In addition, the other of the pair of pipes 646c discharges the heat medium that has flown through the inside of the corrugated plate 646a.

In FIG. 6, as indicated by the outlined arrows, the pair of flat plates 646b are held by jigs, which are not illustrated, and pulled so as to be separated from each other in the X direction. As a result, the overall length of the temperature control plate 646 in the X direction can be adjusted to be a reference value.

As illustrated in FIG. 3, the stacked body 620 includes the temperature control plates 646. Here, the overall length of each of the temperature control plates 646 in the X direction may vary due to manufacturing errors, allowable errors, or the like. In the temperature control plate pulling step S102, in order to reduce such variations of each temperature control plate 646, the temperature control plate 646 is pulled by jigs, which are not illustrated, and the overall length of the temperature control plate 646 in the X direction is adjusted to be the reference value.

The adhesive applying step S104 is a process of applying an adhesive AD to both surfaces of the corrugated plate 646a in the Y direction. Before the application of the adhesive AD, the shape of the corrugated plate 646a is measured. In the present embodiment, the shape of the corrugated plate 646a is measured using a laser measurement apparatus 660. In addition, the adhesive AD is applied using an application apparatus 670.

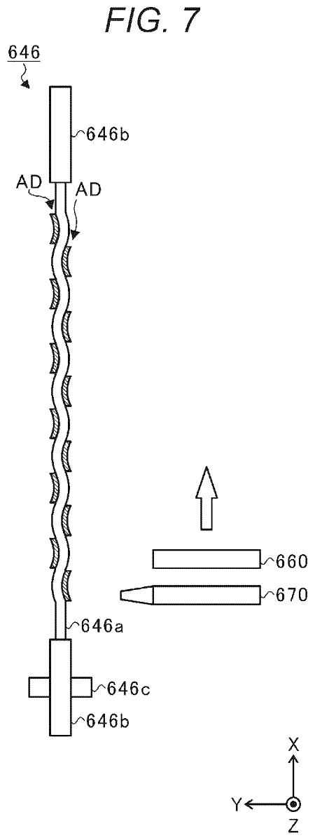

FIG. 7 is a schematic view illustrating configurations of the laser measurement apparatus 660 and the application apparatus 670 according to the present embodiment. As illustrated in FIG. 7, first, the laser measurement apparatus 660 performs laser measurement on the corrugated shape on the −Y direction side of the corrugated plate 646a while moving in the X direction. Then, the application apparatus 670 applies the adhesive AD to the surface on the −Y direction side of the corrugated plate 646a while moving in the X direction based on the measurement result of the laser measurement apparatus 660. As illustrated in FIG. 7, the adhesive AD is provided at recessed portions on the surface on the −Y direction side of the corrugated plate 646a. For example, the adhesives AD are provided apart from each other in the X direction at recessed portions on the surface on the −Y direction side of the corrugated plate 646a.

Similarly, the laser measurement apparatus 660 performs laser measurement on the corrugated shape on the +Y direction side of the corrugated plate 646a while moving in the X direction. Then, the application apparatus 670 applies the adhesive AD to the surface on the +Y direction side of the corrugated plate 646a while moving in the X direction based on the measurement result of the laser measurement apparatus 660. As illustrated in FIG. 7, the adhesive AD is provided at recessed portions on the surface on the +Y direction side of the corrugated plate 646a. For example, the adhesives AD are provided apart from each other in the X direction at recessed portions on the surface on the +Y direction side of the corrugated plate 646a.

In the present embodiment, for example, one laser measurement apparatus 660 is disposed on the −Y direction side of the corrugated plate 646a. After measuring the surface on the −Y direction side of the corrugated plate 646a, the laser measurement apparatus 660 rotates the temperature control plate 646 180° about a Z axis and measures the surface on the +Y direction side of the corrugated plate 646a. However, it is not limited thereto, and a pair of laser measurement apparatuses 660 may be disposed on both sides of the corrugated plate 646a in the Y direction. In this case, the laser measurement apparatuses 660 simultaneously measure the surface on the −Y direction side and the surface on the +Y direction side of the corrugated plate 646a.

The first interval adjusting step S106 is a process of adjusting the interval of the first cell group 642 in the X direction. In the present embodiment, jigs 700 are used to adjust the interval of the first cell group 642 in the X direction. The jigs 700 are third jigs according to the present embodiment.

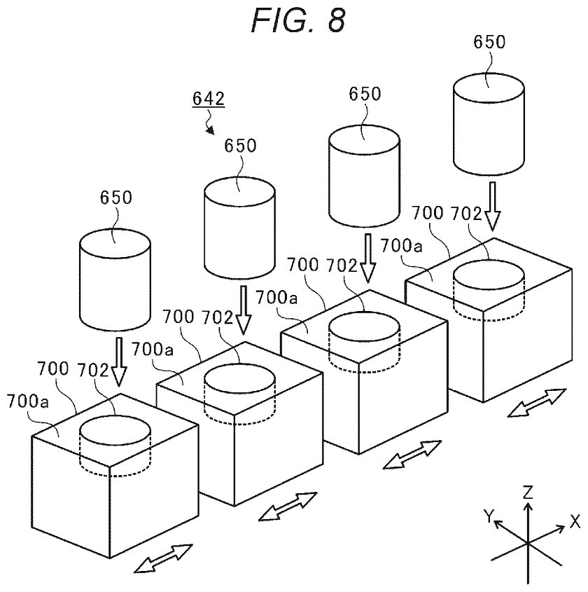

FIG. 8 is a schematic perspective view of the jigs 700 according to the present embodiment. Note that although FIG. 8 illustrates an example in which the number of jigs 700 is four in order to make the drawing easily viewable, the number of jigs 700 may be at least two or more and is not limited to four. As illustrated in FIG. 8, the jigs 700 have, for example, a rectangular parallelepiped shape. The shapes and sizes of the jigs 700 are the same.

A holder 702 for holding the cell 650 is formed on an upper surface 700a of each jig 700 in the +Z direction. The holder 702 is, for example, a hollow provided at the center of the upper surface 700a and recessed in the −Z direction from the upper surface 700a. However, the holder 702 may have a function of holding the cell 650, and is not limited to the hollow. For example, the holder 702 may be at least three or more pins that protrude from the upper surface 700a in the +Z direction and can abut on an outer peripheral surface of the cell 650.

The shape of the holder 702 is a shape corresponding to an outer shape of the cell 650. For example, when the outer shape of the cell 650 is a cylindrical shape, the shape of the holder 702 is a cylindrical shape. The size of an inner diameter of the holder 702 is, for example, substantially the same as the size of an outer diameter of the cell 650, and is slightly larger than the size of the outer diameter of the cell 650. However, it is not limited thereto, and the size of the inner diameter of the holder 702 may be larger than the size of the outer diameter of the cell 650.

As illustrated in FIG. 8, the jigs 700 are disposed in a line in the X direction. In addition, the jigs 700 are configured to be movable in the X direction. That is, the jigs 700 can move in a direction away from each other or in a direction approaching each other in the X direction. This makes it possible to adjust the interval in the X direction between the jigs 700. Note that the positions of the jigs 700 in the Y direction and the Z direction substantially coincide with each other, and the movement of the jigs 700 in the Y direction and the Z direction is restricted. Accordingly, the interval between the jigs 700 in the X direction can be adjusted while maintaining the positional relationship between the jigs 700 in the Y direction and the Z direction. However, the movement of each jig 700 in at least one of the Y direction and the Z direction may not be restricted.

Next, the operation of the jigs 700 will be described. First, the cells 650 housed in a pallet, which is not illustrated, are taken out one by one from the pallet by a robotic arm, which is not illustrated. As illustrated in FIG. 8, the cells 650 taken out from the pallet by the robotic arm are disposed at positions above the holders 702 on the upper surfaces 700a of the jigs 700 in the +Z direction.

Then, by moving the cells 650 in the −Z direction by the robotic arm, the cells 650 are inserted into the holders 702, and one cell 650 is held by the holder 702 of one jig 700. Therefore, the number of jigs 700 is the same as the number of cells 650 included in the first cell group 642.

The holder 702 abuts on the outer peripheral surface of the cell 650 to restrict the movement of the cell 650 in the X direction and the Y direction. In addition, the holder 702 abuts on a bottom surface of the cell 650 to restrict the movement of the cell 650 in the −Z direction. That is, the holder 702 has a function as a movement restrictor that restricts the movement of the cell 650 or a function as a positioner that determines the position of the cell 650.

The cells 650 are inserted into and held by the holders 702 of the jigs 700, so that the first cell group 642 arranged in the X direction is formed. Here, when each jig 700 is moved in the X direction, the cell 650 held by each jig 700 also moves integrally with the jig 700. Therefore, by adjusting the interval of the jigs 700 in the X direction, the interval of the cells 650 in the X direction, and eventually, the interval of the cells 650 of the first cell group 642 in the X direction can be adjusted.

As described above, in the first interval adjusting step S106, the cells 650 of the first cell group 642 are disposed in the respective jigs 700 that are movable in the X direction, and the interval of the cells 650 of the first cell group 642 in the X direction is adjusted. For example, the interval between the cells 650 is set to a target value in a state where the adjacent jigs 700 abut on each other in the X direction and all the jigs 700 are arranged without gaps. In this case, when the jigs 700 positioned at both ends among the jigs 700 arranged in the X direction are pushed so as to approach each other, the jigs 700 are brought into the above-described state, and the adjustment of the interval between the cells 650 is completed.

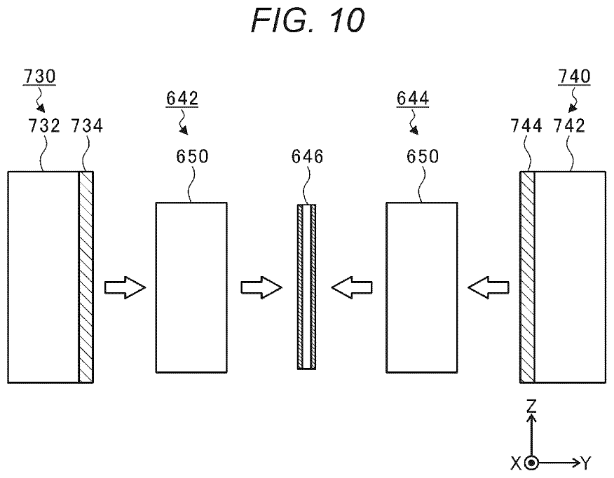

The first cell group 642 in which the interval between the cells 650 is adjusted is disposed at a position on the −Y direction side of the temperature control plate 646 as illustrated in FIG. 10 to be described below.

The second interval adjusting step S108 is a process of adjusting the interval of the second cell group 644 in the X direction. In the present embodiment, jigs 710 are used to adjust the interval of the second cell group 644 in the X direction. The jigs 710 are fourth jigs according to the present embodiment.

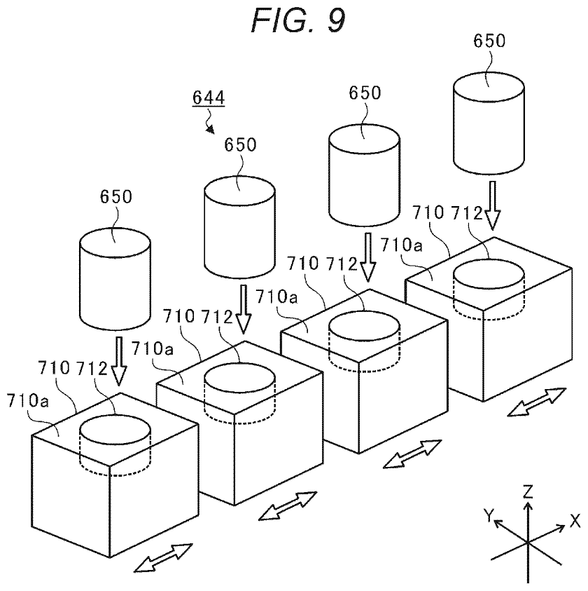

FIG. 9 is a schematic perspective view of the jigs 710 according to the present embodiment. Note that although FIG. 9 illustrates an example in which the number of jigs 710 is four in order to make the drawing easily viewable, the number of jigs 710 may be at least two or more and is not limited to four. As illustrated in FIG. 9, the jigs 710 have, for example, a rectangular parallelepiped shape. The shapes and sizes of the jigs 710 are the same.

A holder 712 for holding the cell 650 is formed on an upper surface 710a of each jig 710 in the +Z direction. The holder 712 is, for example, a hollow provided at the center of the upper surface 710a and recessed in the −Z direction from the upper surface 710a. However, the holder 712 may have a function of holding the cell 650, and is not limited to the hollow. For example, the holder 712 may be at least three or more pins that protrude from the upper surface 710a in the +Z direction and can abut on an outer peripheral surface of the cell 650.

The shape of the holder 712 is a shape corresponding to an outer shape of the cell 650. For example, when the outer shape of the cell 650 is a cylindrical shape, the shape of the holder 712 is a cylindrical shape. The size of an inner diameter of the holder 712 is, for example, substantially the same as the size of an outer diameter of the cell 650, and is slightly larger than the size of the outer diameter of the cell 650. However, it is not limited thereto, and the size of the inner diameter of the holder 712 may be larger than the size of the outer diameter of the cell 650.

As illustrated in FIG. 9, the jigs 710 are disposed in a line in the X direction. In addition, the jigs 710 are configured to be movable in the X direction. That is, the jigs 710 can move in a direction away from each other or in a direction approaching each other in the X direction. This makes it possible to adjust the interval in the X direction between the jigs 710. Note that the positions of the jigs 710 in the Y direction and the Z direction substantially coincide with each other, and the movement of the jigs 710 in the Y direction and the Z direction is restricted. Accordingly, the interval between the jigs 710 in the X direction can be adjusted while maintaining the positional relationship between the jigs 710 in the Y direction and the Z direction. However, the movement of each jig 710 in at least one of the Y direction and the Z direction may not be restricted.

Next, the operation of the jigs 710 will be described. First, the cells 650 housed in a pallet, which is not illustrated, are taken out one by one from the pallet by a robotic arm, which is not illustrated. As illustrated in FIG. 9, the cells 650 taken out from the pallet by the robotic arm are disposed at positions above the holders 712 on the upper surfaces 710a of the jigs 710 in the +Z direction.

Then, by moving the cells 650 in the −Z direction by the robotic arm, the cells 650 are inserted into the holders 712, and one cell 650 is held by the holder 712 of one jig 710. Therefore, the number of jigs 710 is the same as the number of cells 650 included in the second cell group 644.

The holder 712 abuts on the outer peripheral surface of the cell 650 to restrict the movement of the cell 650 in the X direction and the Y direction. In addition, the holder 712 abuts on a bottom surface of the cell 650 to restrict the movement of the cell 650 in the −Z direction. That is, the holder 712 has a function as a movement restrictor that restricts the movement of the cell 650 or a function as a positioner that determines the position of the cell 650.

The cells 650 are inserted into and held by the holders 712 of the jigs 710, so that the second cell group 644 arranged in the X direction is formed. Here, when each jig 710 is moved in the X direction, the cell 650 held by each jig 710 also moves integrally with the jig 710. Therefore, by adjusting the interval of the jigs 710 in the X direction, the interval of the cells 650 in the X direction, and eventually, the interval of the cells 650 of the second cell group 644 in the X direction can be adjusted.

As described above, in the second interval adjusting step S108, the cells 650 of the second cell group 644 are disposed in the respective jigs 710 that are movable in the X direction, and the interval of the cells 650 of the second cell group 644 in the X direction is adjusted. For example, the interval between the cells 650 is set to a target value in a state where the adjacent jigs 710 abut on each other in the X direction and all the jigs 710 are arranged without gaps. In this case, when the jigs 710 positioned at both ends among the jigs 710 arranged in the X direction are pushed so as to approach each other, the jigs 710 are brought into the above-described state, and the adjustment of the interval between the cells 650 is completed.

The second cell group 644 in which the interval between the cells 650 is adjusted is disposed at a position on the +Y direction side of the temperature control plate 646 as illustrated in FIG. 10 to be described below. In this way, the first cell group 642 and the second cell group 644 in which the interval between the cells 650 is adjusted are disposed on both sides of the temperature control plate 646 in the Y direction.

The first jig disposing step S110 is a process of disposing a jig 730 for pressing the first cell group 642 against the temperature control plate 646. The jig 730 is a first jig according to the present embodiment. The second jig disposing step S112 is a process of disposing a jig 740 for pressing the second cell group 644 against the temperature control plate 646. The jig 740 is a second jig according to the present embodiment.

FIG. 10 is a schematic view illustrating a state in which the jigs 730 and 740 according to the present embodiment are disposed with the temperature control plate 646, the first cell group 642, and the second cell group 644 interposed therebetween. As illustrated in FIG. 10, the jig 730 is disposed on the −Y direction side of the temperature control plate 646 and the first cell group 642. The jig 730 is disposed on a side opposite to the temperature control plate 646 with respect to the first cell group 642. That is, the first cell group 642 is disposed between the jig 730 and the temperature control plate 646.

The jig 730 includes a main body 732 and an elastic body 734. The elastic body 734 is a first elastic body according to the present embodiment. The main body 732 has, for example, a flat plate shape having a surface parallel to the XZ plane. The elastic body 734 is made of, for example, sponge or rubber, and is provided on a surface on the +Y direction side of the main body 732. That is, the elastic body 734 is provided between the main body 732 and the first cell group 642. A detailed configuration of the elastic body 734 will be described below.

The jig 740 is disposed on the +Y direction side of the temperature control plate 646 and the second cell group 644. The jig 740 is disposed on a side opposite to the temperature control plate 646 with respect to the second cell group 644. That is, the second cell group 644 is disposed between the jig 740 and the temperature control plate 646.

The jig 740 includes a main body 742 and an elastic body 744. The elastic body 744 is a second elastic body according to the present embodiment. The main body 742 has, for example, a flat plate shape having a surface parallel to the XZ plane. The elastic body 744 is made of, for example, sponge or rubber, and is provided on a surface on the −Y direction side of the main body 742. That is, the elastic body 744 is provided between the main body 742 and the second cell group 644. A detailed configuration of the elastic body 744 will be described below.

In this manner, in the first jig disposing step S110, the jig 730 including the elastic body 734 is disposed on one side of the temperature control plate 646 with the first cell group 642 interposed therebetween. In addition, in the second jig disposing step S112, the jig 740 including the elastic body 744 is disposed on the other side of the temperature control plate 646 with the second cell group 644 interposed therebetween.

The first pressing step S114 is a process of pressing the jig 730 and the jig 740 toward the temperature control plate 646. Pressing by the jig 730 and the jig 740 is performed using, for example, a drive apparatus, which is not illustrated. For example, the jig 730 and the jig 740 are brought close to each other such that the elastic body 734 is in contact with the first cell group 642 and the elastic body 744 is in contact with the second cell group 644, thereby pressing the first cell group 642 and the second cell group 644 against the temperature control plate 646.

Since the elastic bodies 734 and 744 press the cells 650 of the first cell group 642 and the second cell group 644, it is possible to press the cells 650 against the temperature control plate 646 while accommodating variations such as manufacturing errors and allowable errors of the cells 650. Therefore, even when the shape and size of each cell 650 vary, the shapes of the elastic bodies 734 and 744 are deformed so as to conform to the shape of each cell 650, and all the cells 650 can be pressed against the temperature control plate 646. Therefore, it is possible to suppress a situation in which some of the cells 650 are not pressed against the temperature control plate 646 and are not bonded to the temperature control plate 646. In addition, it is possible to prevent an excessive load from being locally applied to the temperature control plate 646 and some of the cells 650. As a result, damage to the temperature control plate 646 and the cell 650 can be suppressed.

When the first cell group 642 and the temperature control plate 646 come close to each other by the pressing by the jig 730 and the adhesives AD of the temperature control plate 646 and the first cell group 642 come into contact with each other, the temperature control plate 646 and the first cell group 642 are bonded to each other by the adhesives AD. In addition, when the second cell group 644 and the temperature control plate 646 come close to each other by the pressing by the jig 740 and the adhesives AD of the temperature control plate 646 and the second cell group 644 come into contact with each other, the temperature control plate 646 and the second cell group 644 are bonded to each other by the adhesives AD. In this way, the first cell group 642, the second cell group 644, and the temperature control plates 646 are bonded to each other, and the unit 640 including the first cell group 642, the second cell group 644, and the temperature control plate 646 as one piece is created.

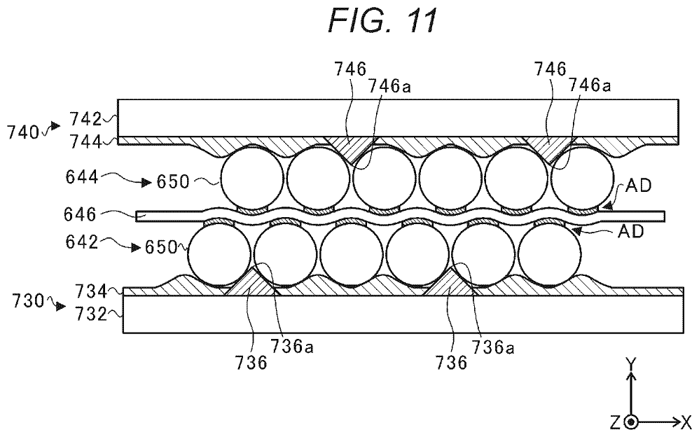

FIG. 11 is a schematic view illustrating a state in which the first cell group 642 and the second cell group 644 are pressed against the temperature control plate 646 by the jigs 730 and 740 according to the present embodiment. As illustrated in FIG. 11, the elastic body 734 is formed in a corrugated shape such that the pressing surface on the +Y direction side becomes close to the outer shape of the first cell group 642. However, it is not limited thereto, and the shape of the pressing surface of the elastic body 734 on the +Y direction side may be, for example, a planar shape. In addition, the elastic body 734 includes projections 736 for securing a gap between the cells 650 of the first cell group 642. The projections 736 are provided for each distance corresponding to a multiple of the interval between the cells 650 in the X direction.

The shape of an XY cross section of the projection 736 is, for example, a triangular shape. By inserting an apex 736a of the projection 736 on the +Y direction side between the two adjacent cells 650, the two adjacent cells 650 can be separated in the X direction. That is, it is possible to prevent the two adjacent cells 650 from coming into contact with each other in the X direction.

In the example illustrated in FIG. 11, the projections 736 are provided for each distance corresponding to a multiple of 3 of the interval between the centers of the adjacent cells 650 in the X direction. The interval between the projections 736 in the X direction corresponds to the length in the X direction of each group of the cells 650 coupled to the common bus bar 634 in the first cell group 642. For example, the interval between the projections 736 in the X direction corresponds to a distance between the position in the X direction of the cell 650 at one end and the position in the X direction of the cell 650 at the other end in the X direction of the group. As a result, it is possible to reduce electrical short circuit or electric leakage between groups of the cells 650 coupled to the common bus bar 634 in the first cell group 642.

Similarly, the elastic body 744 is formed in a corrugated shape such that the pressing surface on the −Y direction side becomes close to the outer shape of the second cell group 644. However, it is not limited thereto, and the shape of the pressing surface of the elastic body 744 on the −Y direction side may be, for example, a planar shape. In addition, the elastic body 744 includes projections 746 for securing a gap between the cells 650 of the second cell group 644. The projections 746 are provided for each distance corresponding to a multiple of the interval between the cells 650 in the X direction.

The shape of an XY cross section of the projection 746 is, for example, a triangular shape. By inserting an apex 746a of the projection 746 on the −Y direction side between the two adjacent cells 650, the two adjacent cells 650 can be separated in the X direction. That is, it is possible to prevent the two adjacent cells 650 from coming into contact with each other in the X direction.

In the example illustrated in FIG. 11, the projections 746 are provided for each distance corresponding to a multiple of 3 of the interval between the centers of the adjacent cells 650 in the X direction. The interval between the projections 746 in the X direction corresponds to the length in the X direction of each group of the cells 650 coupled to the common bus bar 634 in the second cell group 644. For example, the interval between the projections 746 in the X direction corresponds to a distance between the position in the X direction of the cell 650 at one end and the position in the X direction of the cell 650 at the other end in the X direction of the group. As a result, it is possible to reduce electrical short circuit or electric leakage between groups of the cells 650 coupled to the common bus bar 634 in the second cell group 644.

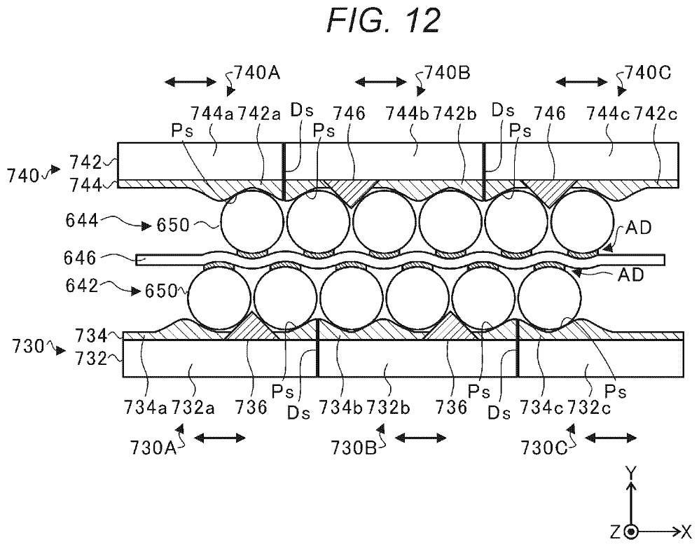

FIG. 12 is a schematic view illustrating a state in which the first cell group 642 and the second cell group 644 are pressed against the temperature control plate 646 by the jigs 730 and 740 according to a modification. As illustrated in FIG. 12, in the modification, the jig 730 includes divided bodies 730A, 730B, and 730C divided in the X direction and configured to be movable in the X direction.

The divided body 730A includes a sub-main body 732a that is a part of the main body 732 and a sub-elastic body 734a that is a part of the elastic body 734. The divided body 730B includes a sub-main body 732b that is a part of the main body 732 and a sub-elastic body 734b that is a part of the elastic body 734. The divided body 730C includes a sub-main body 732c that is a part of the main body 732 and a sub-elastic body 734c that is a part of the elastic body 734.

The divided bodies 730A, 730B, and 730C are disposed in a line in the X direction. In addition, the divided bodies 730A, 730B, and 730C are configured to be movable in the X direction. That is, the divided bodies 730A, 730B, and 730C can move in a direction away from each other or in a direction approaching each other in the X direction. This makes it possible to adjust the interval in the X direction between the divided bodies 730A, 730B, and 730C. Note that the positions of the divided bodies 730A, 730B, and 730C in the Y direction and the Z direction substantially coincide with each other. In addition, the movement of the divided bodies 730A, 730B, and 730C in the Z direction is restricted. Accordingly, the interval between the divided bodies 730A, 730B, and 730C in the X direction can be adjusted while maintaining the positional relationship between the divided bodies 730A, 730B, and 730C in the Z direction. However, the movement of the divided bodies 730A, 730B, and 730C in the Z direction may not be restricted.

The positions of division planes Ds of the divided bodies 730A, 730B, and 730C are different from the positions of pressing members Ps where the elastic body 734 presses the cells 650 in the X direction. For example, the positions of the division planes Ds are non-contact positions where the elastic body 734 does not contact the cells 650. The positions of the division planes Ds are, for example, positions between the cells 650 adjacent in the X direction.

The jig 740 includes divided bodies 740A, 740B, and 740C divided in the X direction and configured to be movable in the X direction. The divided body 740A includes a sub-main body 742a that is a part of the main body 742 and a sub-elastic body 744a that is a part of the elastic body 744. The divided body 740B includes a sub-main body 742b that is a part of the main body 742 and a sub-elastic body 744b that is a part of the elastic body 744. The divided body 740C includes a sub-main body 742c that is a part of the main body 742 and a sub-elastic body 744c that is a part of the elastic body 744.

The divided bodies 740A, 740B, and 740C are disposed in a line in the X direction. In addition, the divided bodies 740A, 740B, and 740C are configured to be movable in the X direction. That is, the divided bodies 740A, 740B, and 740C can move in a direction away from each other or in a direction approaching each other in the X direction. This makes it possible to adjust the interval in the X direction between the divided bodies 740A, 740B, and 740C. Note that the positions of the divided bodies 740A, 740B, and 740C in the Y direction and the Z direction substantially coincide with each other. In addition, the movement of the divided bodies 740A, 740B, and 740C in the Z direction is restricted. Accordingly, the interval between the divided bodies 740A, 740B, and 740C in the X direction can be adjusted while maintaining the positional relationship between the divided bodies 740A, 740B, and 740C in the Z direction. However, the movement of the divided bodies 740A, 740B, and 740C in the Z direction may not be restricted.

The positions of division planes Ds of the divided bodies 740A, 740B, and 740C are different from the positions of pressing members Ps where the elastic body 744 presses the cells 650 in the X direction. For example, the positions of the division planes Ds are non-contact positions where the elastic body 744 does not contact the cells 650. The positions of the division planes Ds are, for example, positions between the cells 650 adjacent in the X direction.

As described above, the length in the X direction of each temperature control plate 646 included in the stacked body 620 may include variations such as manufacturing errors and allowable errors. Since the jig 730 includes the divided bodies 730A, 730B, and 730C configured to be movable in the X direction, the interval between the divided bodies 730A, 730B, and 730C in the X direction can be adjusted according to the variations in the length in the X direction of each temperature control plate 646. As a result, each cell 650 can be appropriately pressed against the temperature control plate 646 while the variations in the length in the X direction of each temperature control plate 646 are accommodated. Similarly, since the jig 740 includes the divided bodies 740A, 740B, and 740C configured to be movable in the X direction, the interval between the divided bodies 740A, 740B, and 740C in the X direction can be adjusted according to the variations in the length in the X direction of each temperature control plate 646. As a result, each cell 650 can be appropriately pressed against the temperature control plate 646 while the variations in the length in the X direction of each temperature control plate 646 are accommodated.

The housing step S116 is a process of housing the unit 640 in a main body 752 having a box shape of a jig 750 in order to cure the adhesive AD for bonding the first cell group 642, the second cell group 644, and the temperature control plate 646.

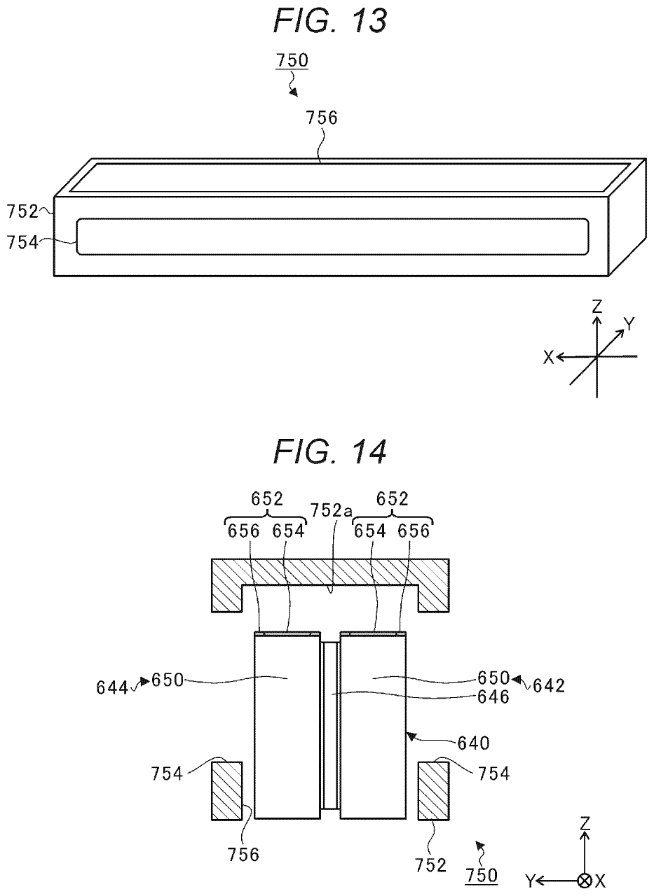

FIG. 13 is a schematic view illustrating a configuration of the jig 750 according to the present embodiment. As illustrated in FIG. 13, the jig 750 includes the main body 752 having a box shape. The main body 752 has, for example, a rectangular parallelepiped shape. The length of the main body 752 in the X direction is larger than the length of the main body 752 in the Y direction, and is larger than the length of the main body 752 in the Z direction. In other words, the width of the main body 752 in the X direction is larger than the depth of the main body 752 in the Y direction, and is larger than the height of the main body 752 in the Z direction.

A pair of first openings 754 are formed in the centers of a pair of side surfaces of the main body 752 in the Y direction. The first openings 754 have, for example, a rectangular shape and extend in the X direction. The length of the first openings 754 in the X direction is larger than the length of the unit 640 in the X direction, for example. Note that the length of the first openings 754 in the Z direction is smaller than the length of the unit 640 in the Z direction.

A second opening 756 is formed in the center of an upper surface of the main body 752 in the +Z direction. In other words, the second opening 756 is formed in the center of the upper surface of the main body 752 on one side in the Z direction. The second opening 756 has, for example, a rectangular shape and extends in the X direction. The length of the second opening 756 in the X direction is larger than the length of the unit 640 in the X direction. In addition, the length of the second opening 756 in the Y direction is larger than the length of the unit 640 in the Y direction. Therefore, the unit 640 can be introduced into the main body 752 through the second opening 756.

FIG. 14 is a schematic cross-sectional view illustrating a state in which the unit 640 is housed in the main body 752 according to the present embodiment. The unit 640 illustrated in FIG. 14 is a unit 640 in which the first cell group 642, the second cell group 644, and the temperature control plate 646 are bonded by the adhesives AD, and the adhesives AD are in an uncured state. As illustrated in FIG. 14, the main body 752 is moved from the +Z direction side toward the −Z direction of the unit 640 with the second opening 756 of the main body 752 facing the −Z direction. As a result, the unit 640 is introduced into the main body 752, and the unit 640 is housed in the main body 752.

As illustrated in FIG. 14, an electrode 652 is provided at at least one end of both ends of each cell 650. In the example illustrated in FIG. 14, the electrode 652 is provided only at one end of both ends of the cell 650. However, it is not limited thereto, and the electrodes 652 may be provided at both ends of the cell 650.

The electrode 652 includes a positive electrode 654 and a negative electrode 656. The positive electrode 654 has a circular shape when viewed from the Z direction, and is provided at the center of the cell 650. The negative electrode 656 has an annular shape when viewed from the Z direction, and is provided on an outer diameter side of the positive electrode 654.

The second pressing step S118 is a process of pressing the unit 640 until the adhesives AD are cured. In other words, the second pressing step S118 is a process of pressing the unit 640 until the adhesives AD are fixed. A pair of first pressing members 760 and a second pressing member 770 are used to press the unit 640. The pair of first pressing members 760 and the second pressing member 770 are included in the jig 750.

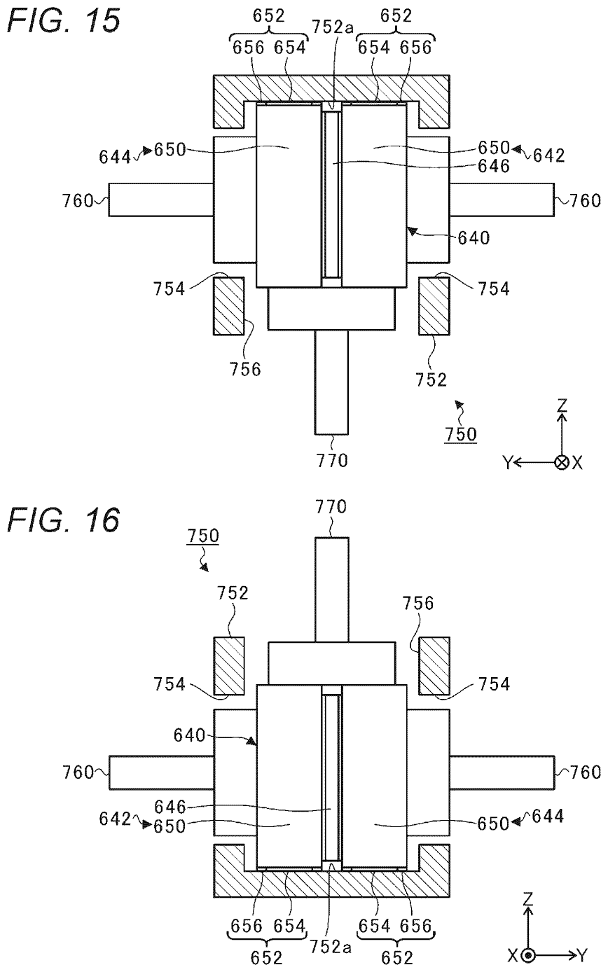

FIG. 15 is a schematic cross-sectional view illustrating a state of the unit 640 pressed by the pair of first pressing members 760 and the second pressing member 770 according to the present embodiment. As illustrated in FIG. 15, one of the pair of first pressing members 760 is disposed on the −Y direction side of the unit 640, and the other of the pair of first pressing members 760 is disposed on the +Y direction side of the unit 640.

The first pressing member 760 disposed on the −Y direction side of the unit 640 presses the first cell group 642 of the unit 640 from the −Y direction side toward the +Y direction. The first pressing member 760 disposed on the +Y direction side of the unit 640 presses the second cell group 644 of the unit 640 from the +Y direction side toward the −Y direction.

In addition, the second pressing member 770 is disposed on the −Z direction side of the unit 640. The second pressing member 770 presses the unit 640 in the +Z direction toward a surface 752a that is a bottom surface of the main body 752.

Thus, the unit 640 is sandwiched by the pair of first pressing members 760 in the Y direction. In addition, the unit 640 is sandwiched between the surface 752a of the main body 752 and the second pressing member 770 in the Z direction.

FIG. 16 is a schematic cross-sectional view illustrating a state in which the jig 750 illustrated in FIG. 15 is reversed 180° about an X axis. As illustrated in FIG. 16, the unit 640 is housed in the main body 752 in a state where the electrodes 652 of the cell 650 are in contact with the surface 752a of the main body 752 in the −Z direction. In other words, the unit 640 is housed in the main body 752 in a state where the electrodes 652 of the cell 650 are in contact with the surface 752a of the main body 752 on the other side in the Z direction. As a result, the positions (height positions) of the electrodes 652 of the cells 650 in the Z direction can be aligned. Note that the states of the jig 750 and the unit 640 transition in the order of the state illustrated in FIG. 14, the state illustrated in FIG. 15, and the state illustrated in FIG. 16. Here, the time during which the state illustrated in FIG. 16 is maintained is much longer than the time obtained by adding the time during which the state illustrated in FIG. 14 is maintained and the time during which the state illustrated in FIG. 15 is maintained. That is, the transition from the state illustrated in FIG. 14 to the state illustrated in FIG. 15 and the transition from the state illustrated in FIG. 15 to the state illustrated in FIG. 16 are quickly performed, and after the transition to the state illustrated in FIG. 16, the states of the jig 750 and the unit 640 are maintained for a long time until the adhesives AD are cured.

In addition, the unit 640 is pressed and held by the pair of first pressing members 760 from both sides in the Y direction. The unit 640 is pressed from both sides in the Y direction by the pair of first pressing members 760 through the pair of first openings 754 for a time until the adhesives AD are fixed. As a result, the adhesives AD can be cured while positioning the first cell group 642 and the second cell group 644 with respect to the temperature control plate 646 in the Y direction.

In addition, the unit 640 is pressed and held in the −Z direction toward the surface 752a of the main body 752 by the second pressing member 770. The unit 640 is pressed in the Z direction by the second pressing member 770 through the second opening 756 for a time until the adhesives AD are fixed. As a result, the adhesives AD can be cured while positioning the first cell group 642 and the second cell group 644 with respect to the temperature control plate 646 in the Z direction.

After the adhesives AD are fixed, the unit 640 in which the first cell group 642, the second cell group 644, and the temperature control plate 646 are integrated is generated.

The insulating sheet disposing step S120 is a process of disposing the insulating sheet 648 on one side in the Y direction of the unit 640. Note that the adhesives AD are applied to the insulating sheet 648. Application of the adhesives AD is performed using the laser measurement apparatus 660 and the application apparatus 670 similarly to the adhesive applying step S104.

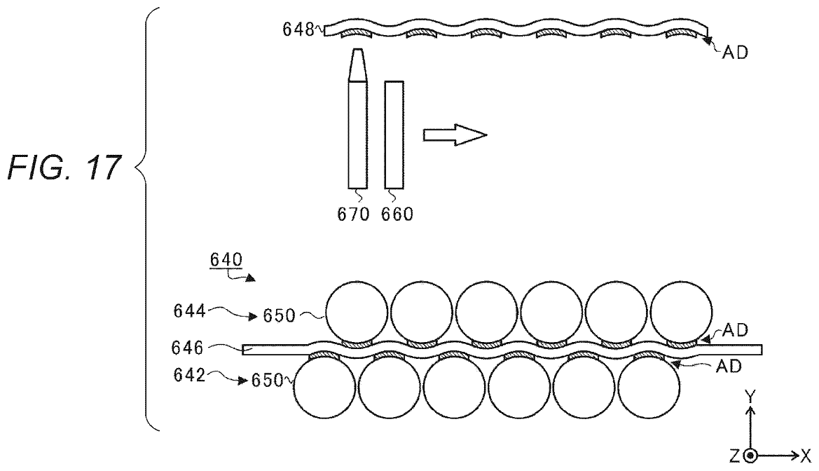

FIG. 17 is a schematic view illustrating a configuration of the insulating sheet 648 according to the present embodiment. The unit 640 illustrated in FIG. 17 is the unit 640 after the adhesives AD are fixed. As illustrated in FIG. 17, the insulating sheet 648 is disposed on a surface of one cell group of the first cell group 642 and the second cell group 644 on a side opposite to the temperature control plate 646 side in the unit 640. In the example illustrated in FIG. 17, the insulating sheet 648 is disposed on the surface of the second cell group 644 on the side opposite to the temperature control plate 646 side. That is, the insulating sheet 648 is disposed on the +Y direction side of the unit 640.

The laser measurement apparatus 660 performs laser measurement on the shape on the −Y direction side of the insulating sheet 648. Then, the application apparatus 670 applies the adhesives AD to the surface on the −Y direction side of the insulating sheet 648 based on the measurement result of the laser measurement apparatus 660.

The rotating body moving step S122 is a process of attaching the insulating sheet 648 to the unit 640. The insulating sheet 648 is attached using a rotating body 780.

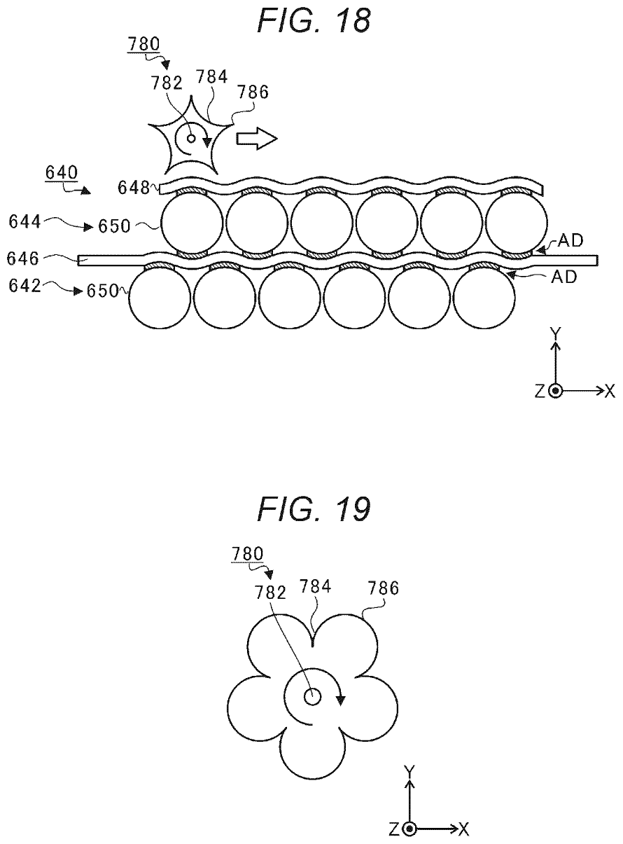

FIG. 18 is a schematic view illustrating a configuration of the rotating body 780 according to the present embodiment. As illustrated in FIG. 18, the rotating body 780 includes a rotation shaft 782, recesses 784, and protrusions 786. The length of the rotating body 780 in the Z direction is the same as the length of the insulating sheet 648 in the Z direction. However, it is not limited thereto, and the length of the rotating body 780 in the Z direction may be larger than the length of the insulating sheet 648 in the Z direction.

The rotation shaft 782 is a shaft serving as a rotation center of the rotating body 780. The rotation shaft 782 extends in the same direction as the central axis of each cell 650. That is, the rotation shaft 782 extends in the Z direction. The rotating body 780 is configured to be rotatable in a clockwise direction or a counterclockwise direction around the rotation shaft 782.

The recesses 784 and the protrusions 786 are alternately provided along a circumferential direction on an outer periphery of the rotating body 780. In the example illustrated in FIG. 18, five recesses 784 are provided on the outer periphery of the rotating body 780. In addition, five protrusions 786 are provided on the outer periphery of the rotating body 780. However, the numbers of the recesses 784 and the protrusions 786 may be two or more, and are not limited thereto. Note that the recesses 784 are provided at equal intervals in the circumferential direction of the rotating body 780. In addition, the protrusions 786 are also provided at equal intervals in the circumferential direction of the rotating body 780.

The recess 784 has a shape corresponding to the outer shape of each cell 650 when viewed from the central axis direction of each cell 650. For example, the recess 784 has a shape along the outer peripheral surface of each cell 650 when viewed from the central axis direction of each cell 650. For example, when the outer shape of each cell 650 is a cylindrical shape, the recess 784 has an arc shape that is a part of the cylindrical shape when viewed from the central axis direction of each cell 650. That is, the recess 784 has the same shape as a part of the outer shape of the cell 650. As a result, adhesion between the insulating sheet 648 and each cell 650 can be enhanced.

The protrusion 786 has a tapered shape in which the width becomes narrower toward a radially outer tip when viewed from the central axis direction of each cell 650. The protrusion 786 recesses a part of the insulating sheet 648 toward the −Y direction side. That is, the protrusion 786 deforms a part of the insulating sheet 648 by pushing the part toward the space between the cells 650 adjacent in the X direction. As a result, when another unit 640 is disposed on the +Y direction side of the insulating sheet 648, the interval in the Y direction between the units 640 can be narrowed by the recessed amount of the insulating sheet 648 toward the −Y direction side. As a result, the overall length of the stacked body 620 in the Y direction can be reduced.

As illustrated in FIG. 18, in the rotating body moving step S122, the rotating body 780 is moved in the X direction by rolling along the surface of the second cell group 644 in a state where the outer periphery of the rotating body 780 is pressed against the insulating sheet 648 from the side opposite to the second cell group 644 side. As a result, the insulating sheet 648 can be appropriately attached to the cells 650 while enhancing the adhesion between each cell 650 and the insulating sheet 648. Further, as described above, the interval in the Y direction between the units 640 can be narrowed.

FIG. 19 is a schematic view illustrating a configuration of the rotating body 780 according to a modification. As illustrated in FIG. 19, the protrusion 786 has an arc shape that is a part of the cylindrical shape when viewed from the central axis direction of each cell 650. In such a modification as well, by moving the rotating body 780 in the X direction while rolling along the surface of the second cell group 644 in a state where the outer periphery of the rotating body 780 is pressed against the insulating sheet 648 from the side opposite to the second cell group 644, the insulating sheet 648 can be appropriately attached to the cells 650 while enhancing the adhesion between each cell 650 and the insulating sheet 648.

In the modification, the recess 784 has a tapered shape in which the width becomes narrower toward a radially inner side when viewed from the central axis direction of each cell 650. However, it is not limited thereto, and the shape of the recess 784 may be the shape of the recess 784 illustrated in FIG. 18. That is, the protrusion 786 may protrude radially outward with respect to the periphery of the outer peripheral surface of the rotating body 780, and the shape of the protrusion 786 is not particularly limited. In addition, the recess 784 may be recessed radially inward with respect to the periphery of the outer peripheral surface of the rotating body 780, and the shape of the recess 784 is not particularly limited.

The stacking step S200 is a process of stacking the units 640 to which the insulating sheets 648 are attached. For example, a coupling pipe, which is not illustrated, is coupled between the pipes 646c of the temperature control plates 646 of the units 640 to couple the units 640. The stacked body 620 is formed by coupling the units 640.

Here, each unit 640 is held by a jig, which is not illustrated. The jig, which is not illustrated, moves to adjust the interval between the units 640. The units 640 are coupled by the coupling pipe, which is not illustrated, while the interval is adjusted by the jig, which is not illustrated. Note that a stopper is provided on the jig, which is not illustrated, and a movement stroke is limited so that the interval between the units 640 is not too small.

As described above, the method for manufacturing the battery module 600 according to the present embodiment is a method for manufacturing the battery module 600 including the stacked body 620 in which the units 640 are stacked, each unit 640 including the first cell group 642 and the second cell group 644 in which the cells 650 extending in the first direction are arranged in the second direction orthogonal to the first direction and the temperature control plate 646 disposed between the first cell group 642 and the second cell group 644 and extending in the second direction.

The method for manufacturing the battery module 600 according to the present embodiment includes the temperature control plate pulling step S102, the adhesive applying step S104, the first interval adjusting step S106, the second interval adjusting step S108, the first jig disposing step S110, the second jig disposing step S112, the first pressing step S114, the housing step S116, the second pressing step S118, the insulating sheet disposing step S120, and the rotating body moving step S122.

In the first jig disposing step S110, the jig 730 including the elastic body 734 is disposed on one side of the temperature control plate 646 with the first cell group 642 interposed therebetween. In addition, in the second jig disposing step S112, the jig 740 including the elastic body 744 is disposed on the other side of the temperature control plate 646 with the second cell group 644 interposed therebetween. In the first pressing step S114, the jig 730 and the jig 740 are brought close to each other such that the elastic body 734 is in contact with the first cell group 642 and the elastic body 744 is in contact with the second cell group 644, thereby pressing the first cell group 642 and the second cell group 644 against the temperature control plate 646. As described above, since the elastic bodies 734 and 744 press the cells 650, it is possible to press the cells 650 against the temperature control plate 646 while accommodating variations such as manufacturing errors and allowable errors of the cells 650. Therefore, even when the shape and size of each cell 650 vary, the shapes of the elastic bodies 734 and 744 are deformed so as to conform to the shape of each cell 650, and all the cells 650 can be pressed against the temperature control plate 646. Therefore, it is possible to suppress a situation in which some of the cells 650 are not pressed against the temperature control plate 646 and are not bonded to the temperature control plate 646. In addition, it is possible to prevent an excessive load from being locally applied to the temperature control plate 646 and some of the cells 650. As a result, damage to the temperature control plate 646 and the cell 650 can be suppressed. As a result, it is possible to facilitate manufacturing of the battery module 600.

In addition, in the first interval adjusting step S106, the cells 650 of the first cell group 642 are disposed in the respective jigs 700 that are movable in the second direction, and the interval of the cells 650 of the first cell group 642 in the second direction is adjusted. In addition, in the second interval adjusting step S108, the cells 650 of the second cell group 644 are disposed in the respective jigs 710 that are movable in the second direction, and the interval of the cells 650 of the second cell group 644 in the second direction is adjusted. As a result, the temperature control plate 646 and the first cell group 642 can be bonded to each other in a state where the interval of the cells 650 of the first cell group 642 in the X direction is accurately adjusted. Similarly, the temperature control plate 646 and the second cell group 644 can be bonded to each other in a state where the interval of the cells 650 of the second cell group 644 in the X direction is accurately adjusted.

In addition, the elastic body 734 of the jig 730 and the elastic body 744 of the jig 740 include the projections 736 and 746 for each distance corresponding to a multiple of the interval between the cells 650 in the second direction. As a result, it is possible to reduce electrical short circuit and electric leakage between groups of the cells 650 coupled to the common bus bar 634 in the first cell group 642. Similarly, it is possible to reduce electrical short circuit and electric leakage between groups of the cells 650 coupled to the common bus bar 634 in the second cell group 644.

In addition, the jig 730 and the jig 740 include divided bodies 730A, 730B, 730C, 740A, 740B, and 740C divided in the second direction and configured to be movable in the second direction. As a result, even when the length of each temperature control plate 646 in the X direction varies, each cell 650 can be appropriately pressed against the temperature control plate 646 while accommodating the variation.

In addition, the positions of the division planes Ds of the divided bodies 730A, 730B, 730C, 740A, 740B, and 740C are different from the positions of pressing members Ps where the elastic bodies 734 and 744 press the cells 650 in the second direction. As a result, each cell 650 can be sufficiently pressed against the temperature control plate 646, and the adhesion force between each cell 650 and the temperature control plate 646 can be enhanced.

In addition, the jigs 730 and 740 according to the present embodiment are jigs used in the method for manufacturing the battery module 600 including the stacked body 620 in which the units 640 are stacked, each unit 640 including the first cell group 642 and the second cell group 644 in which the cells 650 extending in the first direction are arranged in the second direction orthogonal to the first direction and the temperature control plate 646 disposed between the first cell group 642 and the second cell group 644 and extending in the second direction.

The jig 730 includes the elastic body 734 that is disposed on one side of the temperature control plate 646 with the first cell group 642 interposed therebetween. The jig 740 includes the elastic body 744 that is disposed on the other side of the temperature control plate 646 with the second cell group 644 interposed therebetween. The jig 730 and the jig 740 are brought close to each other such that the elastic body 734 is in contact with the first cell group 642 and the elastic body 744 is in contact with the second cell group 644, thereby pressing the first cell group 642 and the second cell group 644 against the temperature control plate 646. As described above, since the elastic bodies 734 and 744 press the cells 650, it is possible to press the cells 650 against the temperature control plate 646 while accommodating variations such as manufacturing errors and allowable errors of the cells 650. Therefore, even when the shape and size of each cell 650 vary, the shapes of the elastic bodies 734 and 744 are deformed so as to conform to the shape of each cell 650, and all the cells 650 can be pressed against the temperature control plate 646. Therefore, it is possible to suppress a situation in which some of the cells 650 are not pressed against the temperature control plate 646 and are not bonded to the temperature control plate 646. In addition, it is possible to prevent an excessive load from being locally applied to the temperature control plate 646 and some of the cells 650. As a result, damage to the temperature control plate 646 and the cell 650 can be suppressed. As a result, it is possible to facilitate manufacturing of the battery module 600.

In addition, the method for manufacturing the battery module 600 according to the present embodiment is a method for manufacturing the battery module 600 including the stacked body 620 in which the units 640 are stacked, each unit 640 including the first cell group 642 and the second cell group 644 in which the cells 650 extending in the first direction are arranged in the second direction orthogonal to the first direction and the temperature control plate 646 disposed between the first cell group 642 and the second cell group 644 with the adhesives AD interposed therebetween and extending in the second direction.

In addition, in the housing step S116, the unit 640 is housed in the main body 752 of the jig 750 including the main body 752 having a box shape and the pair of first openings 754 provided on both sides of the main body 752 in a third direction orthogonal to the first direction and the second direction. Then, in the second pressing step S118, the unit 640 is pressed from both sides in the third direction by the pair of first pressing members 760 through the pair of first openings 754 for a time until the adhesives AD are fixed. As a result, the adhesives AD can be cured while positioning the first cell group 642 and the second cell group 644 with respect to the temperature control plate 646.

In addition, the second opening 756 is provided on one side of the main body 752 in the first direction. Then, in the second pressing step S118, the unit 640 is pressed in the first direction by the second pressing member 770 through the second opening 756 for a time until the adhesives AD are fixed. As a result, the adhesives AD can be cured while positioning the first cell group 642 and the second cell group 644 with respect to the temperature control plate 646.

In addition, the unit 640 is housed in the main body 752 in a state where the electrodes 652 of the cell 650 are in contact with the surface 752a of the main body 752 on the other side in the first direction. As a result, the positions of the electrodes 652 of the cells 650 in the Z direction can be aligned.

In addition, the jig 750 according to the present embodiment is a jig used in the method for manufacturing the battery module 600 including the stacked body 620 in which the units 640 are stacked, each unit 640 including the first cell group 642 and the second cell group 644 in which the cells 650 extending in the first direction are arranged in the second direction orthogonal to the first direction and the temperature control plate 646 disposed between the first cell group 642 and the second cell group 644 with the adhesives AD interposed therebetween and extending in the second direction.

The jig 750 includes the main body 752 having a box shape and the pair of first openings 754 provided on both sides of the main body 752 in the third direction orthogonal to the first direction and the second direction. The main body 752 houses the unit 640. The unit 640 is pressed from both sides in the third direction by the pair of first pressing members 760 through the pair of first openings 754 for a time until the adhesives AD are fixed. As a result, the adhesives AD can be cured while positioning the first cell group 642 and the second cell group 644 with respect to the temperature control plate 646.

In addition, the second opening 756 is provided on one side of the main body 752 in the first direction. Then, the unit 640 is pressed in the first direction by the second pressing member 770 through the second opening 756 for a time until the adhesives AD are fixed. As a result, the adhesives AD can be cured while positioning the first cell group 642 and the second cell group 644 with respect to the temperature control plate 646.

In addition, the unit 640 is housed in the main body 752 in a state where the electrodes 652 of the cell 650 are in contact with the surface of the main body 752 on the other side in the first direction. As a result, the positions of the electrodes 652 of the cells 650 in the Z direction can be aligned.

In addition, the method for manufacturing the battery module 600 according to the present embodiment is a method for manufacturing the battery module 600 including the stacked body 620 in which the units 640 are stacked with the insulating sheets 648 interposed therebetween, each unit 640 including the first cell group 642 and the second cell group 644 in which the cells 650 extending in the first direction are arranged in the second direction orthogonal to the first direction and the temperature control plate 646 disposed between the first cell group 642 and the second cell group 644 and extending in the second direction.

In the insulating sheet disposing step S120, the insulating sheet 648 is disposed on a surface of one cell group of the first cell group 642 and the second cell group 644 on a side opposite to the temperature control plate 646 side in the unit 640. In the rotating body moving step S122, the rotating body 780 including the rotation shaft 782 along the first direction and the recesses 784 and the protrusions 786 alternately provided on the outer periphery along the circumferential direction is moved in the second direction while rolling along the surface of one cell group in a state where the outer periphery is pressed against the insulating sheet 648 from the side opposite to the one cell group side. As a result, adhesion between each cell 650 and the insulating sheet 648 can be enhanced. In addition, the length of the stacked body 620 in the stacking direction can be shortened.

In addition, the cell 650 has a cylindrical shape extending in the first direction. Then, the recess 784 has an arc shape when viewed in the first direction. As a result, the rotating body 780 can be moved following the outer shape of each cell 650, and the adhesion between each cell 650 and the insulating sheet 648 can be enhanced.

In addition, the rotating body 780 according to the present embodiment is a rotating body used in the method for manufacturing the battery module 600 including the stacked body 620 in which the units 640 are stacked with the insulating sheets 648 interposed therebetween, each unit 640 including the first cell group 642 and the second cell group 644 in which the cells 650 extending in the first direction are arranged in the second direction orthogonal to the first direction and the temperature control plate 646 disposed between the first cell group 642 and the second cell group 644 and extending in the second direction.

The rotating body 780 includes the rotation shaft 782 along the first direction, and the recesses 784 and protrusions 786 alternately provided on the outer periphery along the circumferential direction. The insulating sheet 648 is disposed on a surface of one cell group of the first cell group 642 and the second cell group 644 on a side opposite to the temperature control plate 646 side in the unit 640. The rotating body 780 moves in the second direction while rolling along the surface of one cell group in a state where the outer periphery is pressed against the insulating sheet 648 from the side opposite to the one cell group side. As a result, adhesion between each cell 650 and the insulating sheet 648 can be enhanced. In addition, the length of the stacked body 620 in the stacking direction can be shortened.

In addition, the cell 650 has a cylindrical shape extending in the first direction. In addition, the recess 784 has an arc shape when viewed in the first direction. As a result, the rotating body 780 can be moved following the outer shape of each cell 650, and the adhesion between each cell 650 and the insulating sheet 648 can be enhanced.

Although the preferred embodiment of the present disclosure has been described above with reference to the accompanying drawings, it goes without saying that the present disclosure is not limited to such an embodiment. It will be apparent to those skilled in the art that various changes or corrections can be conceived within the scope described in the claims, and it is understood that these naturally fall within the technical scope of the present disclosure. For example, in the above embodiment, the example in which the battery module 600 is used in the vehicle 100 has been described. However, it is not limited thereto, and the battery module 600 may be used in other than the vehicle.

In the above embodiment, the example in which the interval between the cells 650 of the first cell group 642 in the X direction is adjusted by the jigs 700 has been described. However, the adjustment of the interval between the cells 650 of the first cell group 642 in the X direction by the jigs 700 is not essential, and the adjustment may not be performed.

In addition, in the above embodiment, the example in which the interval between the cells 650 of the second cell group 644 in the X direction is adjusted by the jigs 710 has been described. However, the adjustment of the interval between the cells 650 of the second cell group 644 in the X direction by the jigs 710 is not essential, and the adjustment may not be performed.

In addition, in the above embodiment, the example in which the elastic bodies 734 and 744 include the projections 736 and 746 has been described. However, the projections 736 and 746 are not essential components, and the elastic bodies 734 and 744 may not include the projections 736 and 746.

In addition, in the above embodiment, the example has been described in which the division planes Ds of the divided bodies 730A, 730B, 730C, 740A, 740B, and 740C are at the positions different from the pressing members Ps. However, the division planes Ds may be located at the same positions as the pressing members Ps.

In addition, in the above embodiment, the example in which the second pressing member 770 presses the unit 640 in the Z direction has been described. However, the second pressing member 770 is not an essential component, and the second pressing member 770 may not press the unit 640 in the Z direction. In this case, the unit 640 may be brought into contact with the surface 752a, which is the bottom surface of the main body 752, by its own weight, and the height may be aligned by the surface 752a.

In addition, in the above embodiment, the example in which the electrodes 652 of the cell 650 are in contact with the surface 752a of the main body 752 has been described. However, it is not limited thereto, and the electrodes 652 of the cell 650 may not be in contact with the surface 752a of the main body 752.

1. A method for manufacturing a battery module comprising a stacked body in which units are stacked, each unit comprising a first cell group and a second cell group in which cells extending in a first direction are arranged in a second direction orthogonal to the first direction, and a temperature control plate disposed between the first cell group and the second cell group and extending in the second direction, the method comprising:
disposing a first jig comprising a first elastic body across the first cell group on a first side of the temperature control plate;
disposing a second jig comprising a second elastic body across the second cell group on a second side of the temperature control plate; and
pressing the first cell group and the second cell group against the temperature control plate by bringing the first jig and the second jig close to each other such that the first elastic body is in contact with the first cell group and the second elastic body is in contact with the second cell group.

2. The method for manufacturing the battery module according to claim 1, further comprising:
disposing the cells of the first cell group in respective third jigs movable relative to each other in the second direction, and adjusting an interval between the cells of the first cell group in the second direction; and
disposing the cells of the second cell group in respective fourth jigs movable relative to each other in the second direction, and adjusting an interval between the cells of the second cell group in the second direction.

3. The method for manufacturing the battery module according to claim 1, wherein
the first elastic body and the second elastic body comprise projections for each distance corresponding to a multiple of an interval between the cells in the second direction.

4. The method for manufacturing the battery module according to claim 1, wherein
the first jig and the second jig comprise divided bodies divided in the second direction and configured to be movable in the second direction.

5. The method for manufacturing the battery module according to claim 4, wherein
positions of division planes of the divided bodies are different from positions of pressing members where the first elastic body and the second elastic body press the cells in the second direction.

6. A jig used in a method for manufacturing a battery module comprising a stacked body in which units are stacked, each unit comprising a first cell group and a second cell group in which cells extending in a first direction are arranged in a second direction orthogonal to the first direction, and a temperature control plate disposed between the first cell group and the second cell group and extending in the second direction, the jig comprising:
a first jig configured to comprise a first elastic body and be disposed across the first cell group on a first side of the temperature control plate; and
a second jig configured to comprise a second elastic body and be disposed across the second cell group on a second side of the temperature control plate, wherein
the first cell group and the second cell group are pressed against the temperature control plate by bringing the first jig and the second jig close to each other such that the first elastic body is in contact with the first cell group and the second elastic body is in contact with the second cell group.
